(19) United States
(12) Patent Application Publication
(10) Pub. No.: US 2009/0180208 A1
(43) Pub. Date: Jul. 16, 2009

(54) Application specific processor based disk formatter

(75) Inventors: Michael James, Longmont, CO (US); Scott Richmond, Boulder, CO (US)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/008,633

(22) Filed: Jan. 11, 2008

(51) Int. Cl. G11B 5/09

(52) U.S. Cl. 360/48

(57) ABSTRACT

A disk formatter in a disk drive having a main control processor for performing functions relating to transfer of data between a host and at least one disk medium, includes a processor for obtaining sector information of a target sector on the disk medium and issuing commands for reading or writing data on the target sector based on the sector information. A command receiving unit receives the commands for reading or writing issued by the processor and enables reading or writing of the target sector, and a routing unit receives data or status information from the target sector and communicates the data or status information to the processor for enabling the processor to adjust the commands for reading and writing data on the disk sectors based on the data or status information and the sector information.

### FIELD OF INVENTION

The present invention relates to disk drives, and in particular, to an application specific processor based disk formatter provided in the disk controller of a disk drive.

### BACKGROUND OF THE INVENTION

Disk controllers in disk drives, such as magnetic, optical and magneto-optical disk drives, generally include, among other things, a disk formatter for performing data and control path operations. The duties of a disk formatter typically include receiving timing information and controlling the sequence of read or write operations based on the timing information. The disk formatter also controls the length, or amount, of read/write operations allowed on the disk media.

In conventional disk controllers, disk formatters are implemented in finite state machines, which are either flip-flop based (hard coded) or RAM based (writeable control store (WCS)). The hard coded state machines are typically not changeable for new features or issues such as design or manufacturing flaws found after the product is finalized, and as a result, lack flexibility.

The WCS based state machines are more flexible, as new microcode can be created and loaded by the control processor. However, these state machines typically do not have the arithmetic computational features to compensate for timing based issues, such as grown defects or new features.

### SUMMARY OF THE INVENTION

The present invention is directed to a disk formatter in a disk drive having a main control processor for performing functions relating to transfer of data between a host and at least one disk medium. In one embodiment, the disk formatter includes a processor for obtaining sector information of a target sector on the disk medium and issuing commands for reading or writing data on the target sector based on the sector information. A command receiving unit receives the commands for reading or writing issued by the processor and enables reading or writing of the target sector, and a routing unit receives data or status information from the target sector, and communicates the data or status information to the processor for enabling the processor to adjust the commands for reading and writing data on the disk sectors based on the data or status information and the sector information.

### BRIEF DESCRIPTION OF THE DRAWINGS

FIG. 1 is a block diagram of a disk drive in accordance with one embodiment of the present invention;

FIG. 2 is a block diagram of a disk controller provided in the disk drive shown in FIG. 1;

FIG. 3 is a block diagram of a disk formatter in accordance with one embodiment of the present invention;

FIG. 4 is a block diagram of an application specific processor of the disk formatter shown in FIG. 3;

FIG. 5A is an example of a disk format having servo wedges and data sector fields;

FIGS. 5B and 5C are timing diagrams illustrating the operation of a servo counter and a sector counter with respect to the disk format of FIG. 5A;

FIG. 6 is an example of a data sector; and

FIGS. 7A-7C are flowcharts describing the operation of the disk formatter in accordance with one embodiment of the present invention.

### DETAILED DESCRIPTION OF THE PREFERRED EMBODIMENTS

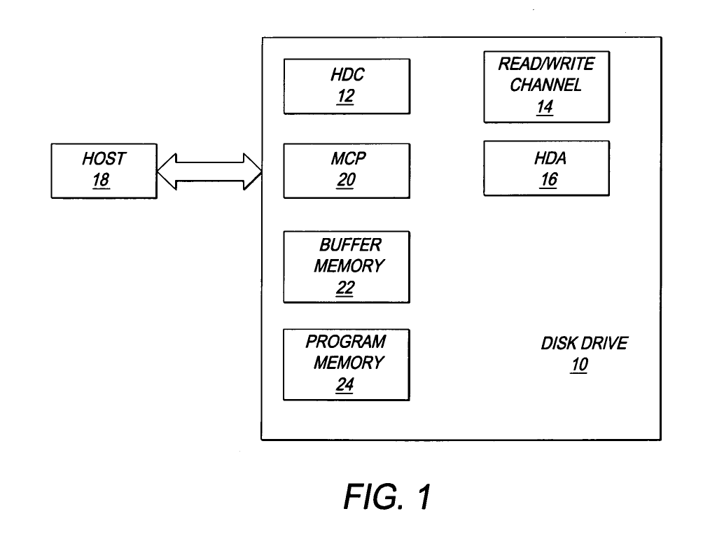

Turning now to FIG. 1, a disk drive 10 in accordance with one embodiment of the present invention includes a hard disk controller (HDC) 12, a read/write channel 14 and a head disk assembly (HDA) 16. The disk drive 10 may be magnetic, optical or magneto-optical disk drives, and is adapted to be communicatively connected to a host device 18 such as a computer.

The disk drive 10 further includes a main control processor (MCP) 20, a buffer memory 22 and a program memory 24. The MCP 20 is provided for the overall control of the disk drive 10 including control and management of the mechanical positioning of the read/write head(s) and rotational media (motor controls) in the HDA 16, management of the buffer memory 22 and its caching algorithms, control and setup of the read/write channel 14 and the host interface, for example. The program memory 24 stores programs and tables (not shown) used in accomplishing the above-mentioned MCP 20 responsibilities, including read channel and buffer management cache tables, codes to be executed by the MCP 20, and user data to be transferred between the host device 18 and media in the HDA 16. The buffer memory 22 stores data used by the MCP 20 and the HDC 12.

The program memory 24 is implemented in a non-volatile device such as a flash memory or a ROM. The HDA 16, although not shown, includes one or more magnetic, optical or magneto-optical disks, a spindle motor for rotating the disks, read/write heads corresponding to the disks for reading data from and writing data on the disks and a head actuator for positioning the heads on the disks.

The read/write channel 14 is provided for translation of digital data from the HDC 12 to a format capable of being either written to, or read from the disk(s) in the HDA 16. In a disk write operation, the read/write channel 14 sends signals to the write head to cause magnetic transitions to be “written” to the disks. For a disk read operation, the read/write channel 14 decodes the signals from the read head generated by passing over the magnetic domains written on the disk. The transitions are detected and processed in a manner that allows them to be converted into a data format usable by the HDC 12 and the host device 18.

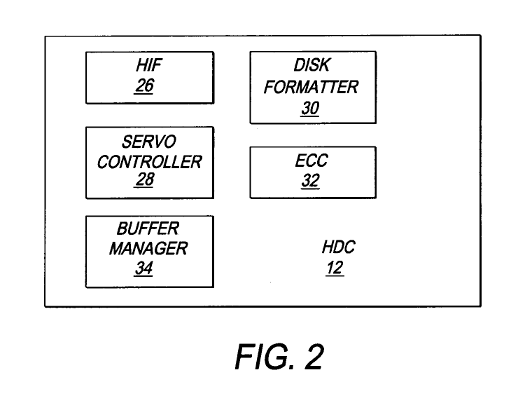

Turning to FIG. 2, the disk controller 12 includes a host interface (HIF) 26 for processing commands from the host device 18, and accepting data from and transmitting disk data to the host device. Status to the host device 18 regarding successes and errors relating to the processing commands are also generated by the HIF 26. A servo controller 28 is provided for controlling the HDA 16 including the rotational speed of the spindle motor used to rotate the disks and positioning of the read/write head.

A disk formatter 30 transfers data from the buffer memory 22 (shown in FIG. 1) to the read/write channel 14, or reads data from the disks and transfers to the buffer memory. The timing of when to write or read data to or from the disk is also controlled by the disk formatter 30. The disk formatter 30 communicates signals to the read/write channel 14 for an indication of when to process data.

An error correcting code (ECC) circuit 32 is provided for recovery of original data as it passes in and out of a disk formatter. A buffer manager 34 is used to interface between the HIF 26 and the buffer memory 22, or the disk formatter 30 and the buffer memory. The HIF 26 and disk formatter 30 make requests of the buffer manager 34 to either accept data and write it to the buffer memory 22, or to retrieve data from the buffer memory. Other components of the disk controller 12 may also have interfaces to the buffer manager 34 to be able to store and retrieve data from the buffer memory 22 including the ECC circuit 32. The buffer manager 34 responsibilities include management of the caching algorithms, which involves searching for a cache hit or miss for each command, and allocation of segments of the buffer memory 22 for different commands or sets of commands.

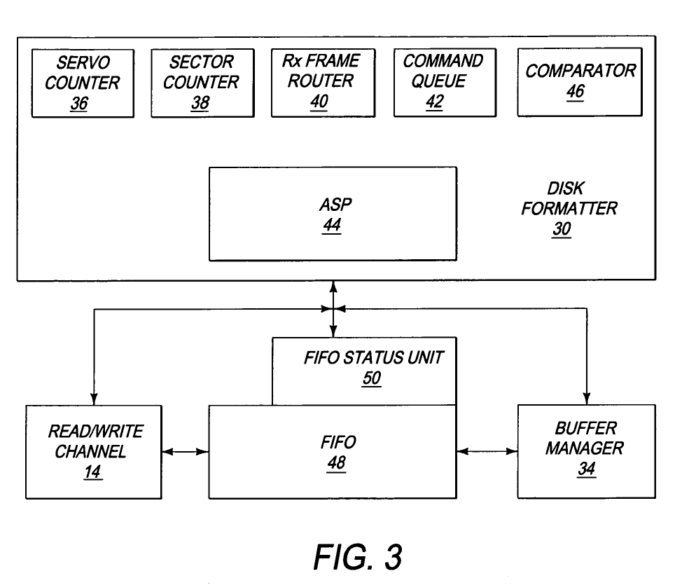

Turning now to FIG. 3, the disk formatter 30 in accordance with one embodiment of the invention includes a servo counter 36 that counts the rotational position between servo wedges on a disk (described below), as well as the servo wedge number most recently passed under the read/write head, and a sector counter 38 for determining the rotational position of the read/write head within the sector. An RX frame router 40 receives data and event notification from the read/write channel. A command queue 42 is provided for receiving and enabling commands from an application specific processor (ASP) 44.

The ASP 44 obtains the format of the target sector by retrieving the predetermined information stored in the buffer memory 22, or some other memory locations. Alternatively, the ASP 44 may calculate the sector information similar to the manner in which the MCP 20 performs this function with respect to known disk drives.

The ASP 44 also makes decisions regarding transfer of data received by the RX frame router 40 to either the buffer manager 34, the ECC circuit 32, or to check and discard the data. Events such as errors and timeouts during a read or write operation are also reported by the RX frame router 40 to the ASP 44. Once the ASP 44 has determined what actions to take to process the data or status requested by the MCP 20, it writes the actions to be performed in the form of a command in the command queue 42. The actions taken by the current command in the command queue 42 include transferring data to and from the read/write channel 14, the buffer manager 34, or the ECC circuit 32. The number of characters to be transferred is also included in the commands placed in the command queue 42.

A comparator 46 is provided in the disk formatter 30 and programmed by the ASP 44 for generating signals that indicate the different fields of the sector on the disk medium. These signals include, but are not limited to, the start of the sector location, the location of the sync characters, the location of read/write channel training characters, the number of characters to transfer to or from the buffer manager 34, the sector split locations, the ECC field locations, and any other fields within a sector of the disk that are needed for the disk formatter 30 to perform its functions of writing and reading data to and from the correct locations on the disk. The comparator 46 also stores values that are compared to the data generated by the servo and sector counters 36, 38 that indicate the location of the head within a sector.

A FIFO 48 is used for temporary storage of data from the read/write channel 14, while the ASP 44 determines, through the RX frame router 40, the destination of the data. Special characters relating to errors or timeouts are also inserted into the FIFO 48, and are used by the ASP 44, through the RX frame router 40, to determine success or error conditions for the sector being processed. A FIFO status unit 50 monitors the data at the output of the FIFO 48 and provides status to the ASP 44 as to whether there is valid data, a status primitive, or nothing valid at the FIFO 48 output. The ASP 44 uses these indicators to know when to read the output of the FIFO 48, or when to transfer data to the buffer memory 22.

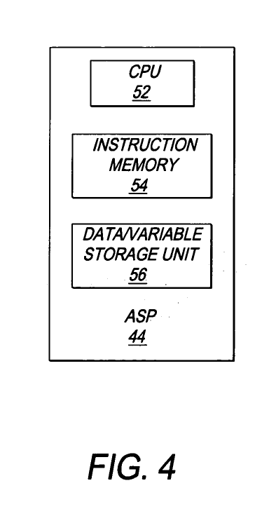

As shown in FIG. 4, the ASP 44 includes a central processing unit (CPU) 52 for enabling the designed functions of the ASP, an instruction memory 54 that contains instructions executed by the ASP, and a local data/variable storage unit 56 for storing data used by the ASP in performing its functions.

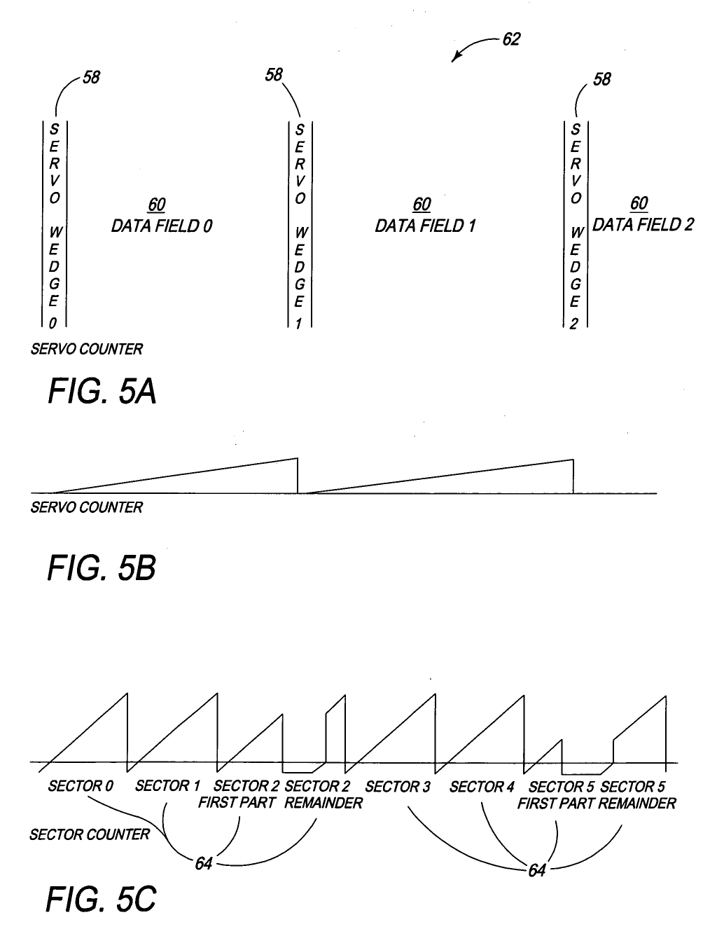

Turning now to FIG. 5A, an example of a disk format having servo wedges 58 and data fields 60 is shown. The servo wedges 58 are areas of a disk 62 which contain information that allows the servo system to know where the read/write head is in both the rotational position as well as the radial position. The servo wedges 58 radiate from the innermost part of the disk recording area outward to the outer portion of the disk recording area, and include track numbers, which are used for gross positioning of the read/write head in the radial direction. The servo wedges 58 also include servo bursts (not shown) to allow the servo system to achieve fine position control. As shown in FIG. 5B, the servo counter 36 counts the rotational position between servo wedges 58, as well the servo wedge number most recently passed under the read/write head. The servo wedge number is used by the comparator 46 for a determination of the gross start of a sector location.

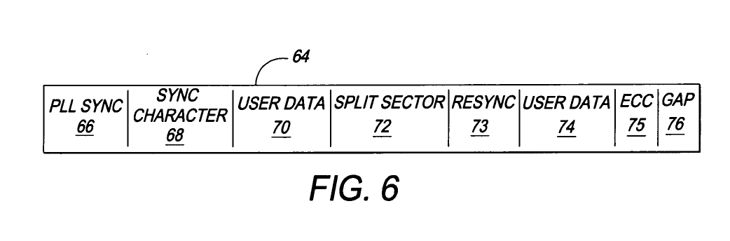

Each data field 60 is divided into a number of data sectors 64, and each sector includes a number of fields, including PLL synchronization 66, a synchronization character 68, user data 70, split sector locations 72, resynchronization 73, user data 74, ECC 75, and inter sector gaps 76 fields, as shown in FIG. 6. The sector counter 38, as shown in FIG. 5C, counts through all the different sectors of the data fields 60.

FIG. 5A illustrates a disk format on a single track of a disk. This illustration contains three servo wedges 58, and two complete data fields 60 between the servo wedges, as well as a portion of the third data field. The progression of the servo counter 36 as shown in FIG. 5B is relative to the servo wedges 58 and the data fields 60.

Data field 0 between the servo wedges 0 and 1 contains two complete data sectors 0 and 1 and partial data sector 2. FIGS. 5A-5C illustrate one method of counting up to a data sector split point (i.e., a servo wedge), saving the count, searching for a sync character value, and restoring the counter to the pre-split value when the sync character value is found to allow sector counter 38 to process the remainder of the split sector's data. Data field 1 is shown to contain the post split section of data sector 2, as well as data sectors 3 and 4 in their entirety. Data sector 5 is split across servo wedge 2, similar to data sector 2, with more data contained in data field 2 than in data field 1.

Referring back to FIG. 3, the operation of the RX frame router 40 is described. For a disk read, the RX frame router 40 takes inputs from the read/write channel 14, the buffer manager 34, and the comparator 46. The RX frame router 40 analyzes these inputs and either discards the data input, or routes it to the FIFO 48. Status primitives are inserted into the FIFO 48 when the start of a sector is reached by the head, when a servo wedge 58 is reached, and a split around a servo wedge occurs. A status primitive for sync character found, a sync character timeout, an ECC error, or other error conditions are also inserted in the FIFO 48. Also, an end of sector status primitive is inserted in the FIFO 48. The ASP 44 reads the status primitives to determine if valid read data is in the FIFO 48, and if so, issues commands to the command queue 42 to direct and transfer the data. For a good sector, the RX frame router 40 will present status primitives to the ASP 44 for a start of sector, and then for a sync character found. This is followed by the user data in the FIFO 48, which through a command from the command queue 42 is written to the buffer memory 22. The ECC data is then transferred from the FIFO 48 to the ECC circuit 32 for error checking. Lastly, a status primitive indicating good or bad ECC and the end of the sector is inserted in the FIFO 48.

For a disk write, the ASP 44 issues a command to the command queue 42 to fill the FIFO 48 with data before searching for the start of sector. Once data is in the FIFO 48, the ASP 44 issues commands to assert write gate, and write the PLL Sync Field 66, then a command to write the sync character 68, followed by commands to write the data from the FIFO 48 to the read/write channel 14, and lastly, a command to transfer data from the ECC circuit 32 to the read/write channel.

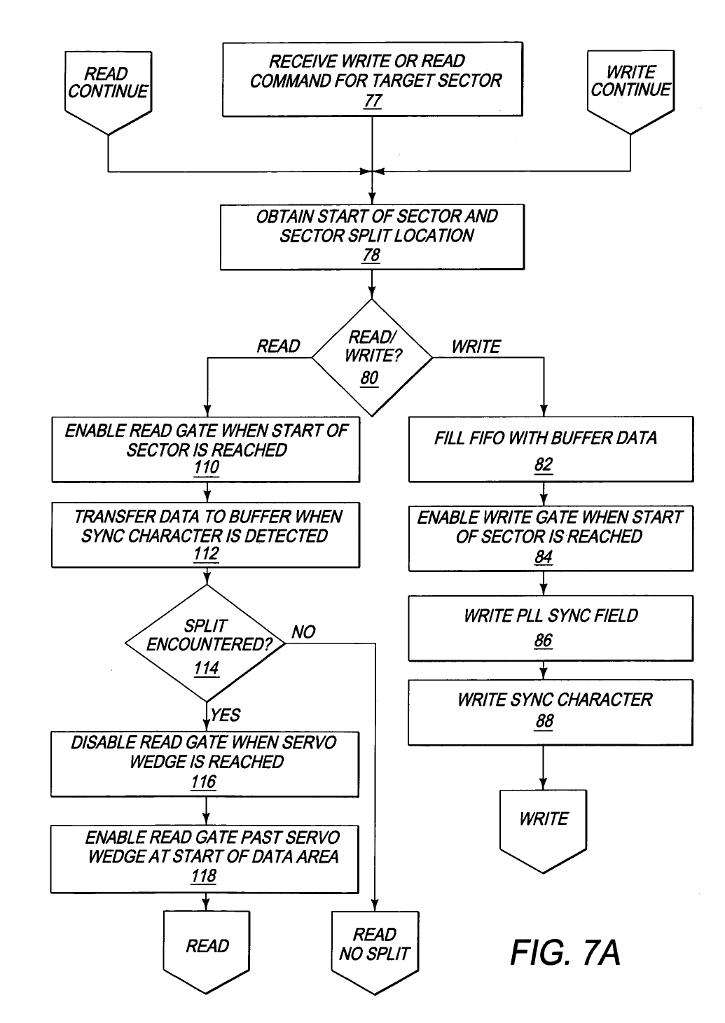

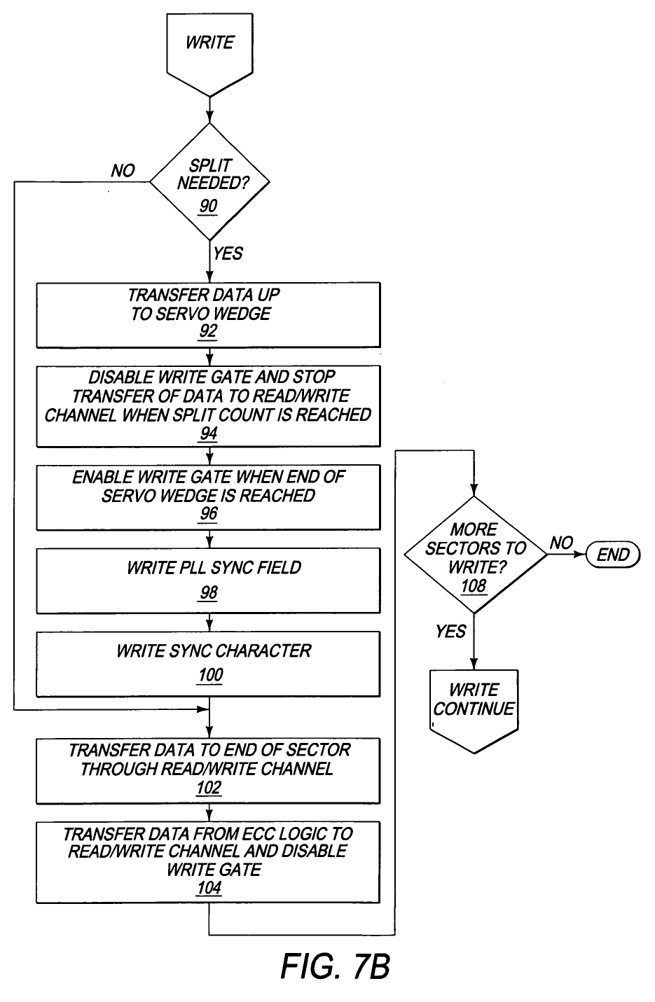

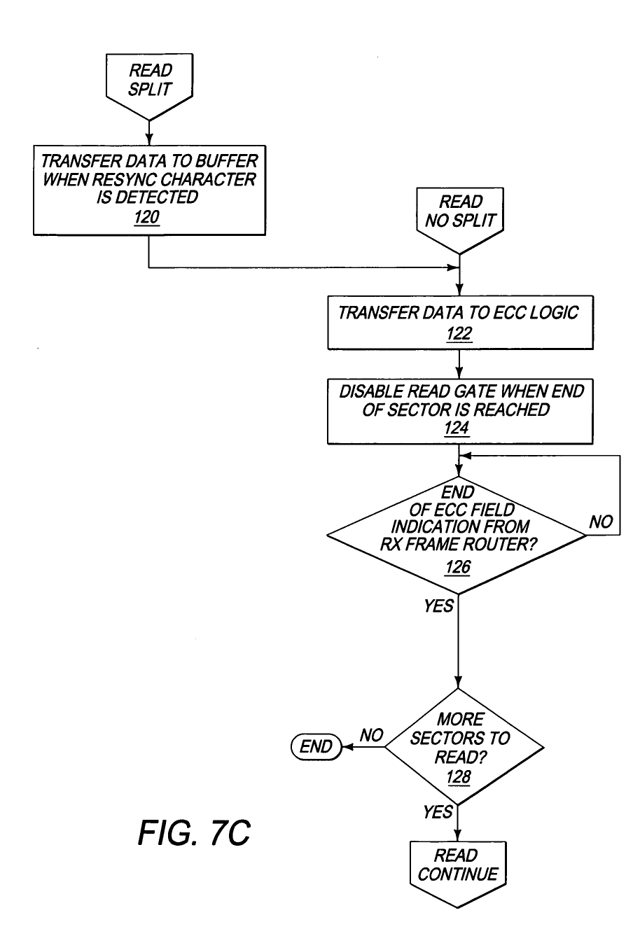

Turning now to FIGS. 7A-7C, the operation of the ASP 44 is described in more detail. When the ASP 44 of the disk formatter 30 receives a write or read command from the MCP 20 (Block 77), it obtains the sector information including the location of the start of target sector and the sector split location, if any (Block 78). The sector information may be predetermined and stored in the buffer memory 22, or some other memory locations. Alternatively, the ASP 44 may calculate the sector information similar to the manner in which the MCP 20 performs this function with respect to known disk drives.

If the command received from the MCP 20 is a write command (Block 80), the ASP 44 issues a command to the command queue 42 to fill the FIFO 48 from the buffer memory 22 with data to be written on the disk (Block 82). The ASP 44 issues a command to the command queue 42 to enable write gate (WG), which is a signal to the read/write channel 14 that enables the writing of data to the disk (Block 84) when the read/write head reaches the start of the target sector. The ASP 44 then issues a command to the command queue 42 to write the preamble in the PLL sync field 66 (Block 86), followed by a command to write the sync character in the sync character field 68 (Block 88). The ASP 44 then determines whether the sector needs to be split based on the sector information retrieved from the memory or calculated by the ASP (Block 90).

If a split is needed in the sector, the ASP 44 issues a command to the command queue 42 to transfer data up to the servo wedge 58 in the data field 70 (Block 92). Then the ASP 44 issues a command to the command queue 42 to disable write gate and stop the transfer of data to the read/write channel 14 when the split count by the servo counter 36 indicates that a sector split location has been reached (Block 94), i.e., when a servo wedge 58 is encountered. The ASP 44 then issues a command to the command queue 42 to again enable write gate when the head has passed the sector split section, i.e., at the end of the servo wedge (Block 96). Thereafter, the ASP 44 issues a command to the command queue 42 to write PLL sync in the field 66 (Block 98) and the sync character in the sync character field 68 (Block 100).

If a split is not needed in the target sector (Block 90), or if a split has occurred and the write sync character step has been completed (Block 100), the ASP 44 issues a command to the command queue 42 to transfer data to the end of the sector through the read/write channel 14 (Block 102). The ASP 44 also issues a command to the command queue 42 to transfer data from the ECC 32 to the read/write channel 14 and disable write gate (Block 104). The ASP 44 then determines whether there are more sectors to write (Block 108). If so, the process returns to Block 78 (FIG. 7A), where the start of sector and sector split location is obtained for the next sector and the process repeats as described above. If no additional sectors need to be written, the process comes to an end.

If the command received in Block 77 is a read command (Block 80), the ASP 44 issues a command to the command queue 42 to enable read gate (RG) when the start of the desired sector is reached by the read/write head (Block 110). A read gate is a signal to the read/write channel 14 to indicate that data is to be read from the disk. The command queue 42 transfers data to the buffer memory 22 when the sync character 68 in the target sector is reached (Block 112).

If during the data transfer a split in the sector is encountered, i.e., a servo wedge 58 (Block 114), the ASP 44 issues a command to the command queue 42 to disable read gate when the split count by the servo counter 36 indicates that a sector split location has been reached (Block 116). Subsequently, the command queue 42 again enables read gate when the head has passed the servo wedge 58 at the start of a data area (Block 118).

After the read gate has been re-enabled after the split section has passed, the ASP 44 issues a command to the command queue 42 to transfer data to the buffer memory 22 from the user data field 74 when the resync character 73 in the target sector is reached (Block 120). Upon transferring data to the buffer memory 22, or when a split is not encountered (in Block 114), the ASP 44 issues a command to the command queue 42 to transfer data to the ECC 32 (Block 122). The ASP 44 then issues a command to the command queue 42 to disable read gate when the end of the sector is reached (Block 124). The ASP 44 then checks the Rx frame router 40 to see whether the end of the ECC field 75 is reached (Block 126). At this point, if there are more sectors to read, the process returns to Block 78 where the sector information is obtained for the next sector (Block 128). Otherwise, the process comes to an end.

The embodiments and examples set forth herein were presented in order to best explain the present invention and its practical application and to thereby enable those skilled in the art to make and use the invention. Those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit and scope of the forthcoming claims.

Various features of the invention are set forth in the appended claims.

What is claimed is:

1. A disk formatter in a disk drive having a main control processor for performing functions relating to transfer of data between a host and at least one disk medium, said disk formatter comprising:
a processor for obtaining sector information of a target sector on the disk medium and issuing commands for reading or writing data on the target sector based on the sector information;
a command receiving unit for receiving the commands for reading or writing issued by the processor and enabling reading or writing of the target sector; and
a routing unit for receiving data or status information from the target sector and communicating the data or status information to the processor for enabling the processor to adjust the commands for reading and writing data on the disk sectors based on the data or status information and the sector information.

2. The disk formatter as defined in claim 1, wherein the sector information comprises information indicating a sector start and a sector split locations of the target sector.

3. The disk formatter as defined in claim 2, wherein the processor retrieves the sector start and the sector split locations of the target sector from a memory.

4. The disk formatter as defined in claim 2, wherein the processor calculates the sector start and the sector split locations of the target sector.

5. The disk formatter as defined in claim 1, wherein the command receiving unit enables data to be sent from a buffer storing the data to a read/write channel and from the read/write channel to the disk when the command received is for writing, and from the disk to a read/write channel and from the read/write channel to the buffer when the command received is for reading.

6. The disk formatter as defined in claim 5, wherein the command receiving unit enables the data to be moved into a memory when the data is being transferred between the buffer and the read/write channel.

7. The disk formatter as defined in claim 6, wherein the memory is a FIFO memory.

8. The disk formatter as defined in claim 7, further comprising a status unit for indicting the status of the FIFO memory to the processor.

9. The disk formatter as defined in claim 1, further comprising:
a servo counter for tracking a plurality of data fields on tracks of the disk medium;
a sector counter for tracking a plurality of sectors provided in the data fields; and
a comparator for comparing tracking information from the servo counter and the sector counter with the sector information obtained by the processor, and outputting a result of the comparison to the routing unit.

10. The disk formatter as defined in claim 9, wherein the servo counter tracks the data fields provided between each pair of a plurality of servo wedges, and the sector counter tracks sectors between the servo wedges and sectors that are split by the servo wedges.

11. A disk apparatus comprising:
a control processor for performing functions relating to transfer of data between a host and at least one disk;
a read/write channel for transferring to the disk medium data to be written to the disk, and receiving from the disk, data read from the disk media;
buffer memory for transferring to the read/write channel the data to be written on the disk, and receiving from the read/write channel the data read from the disk; and
a disk formatter including;
a formatting processor for obtaining sector information of a target sector on the disk and issuing commands for reading or writing data on the target sector based on the sector information;
a command receiving unit for receiving the commands for reading or writing issued by the formatting processor and enabling reading or writing of the target sector; and
a routing unit for receiving data or status information from the target sector and communicating the data or status information to the formatting processor for enabling the formatting processor to adjust the commands for reading and writing data on the disk sectors based on the data or status information and the sector information.

12. The disk apparatus as defined in claim 11, wherein the sector information comprises information indicating a sector start and a sector split locations of the target sector.

13. The disk apparatus as defined in claim 12, wherein the formatting processor retrieves the sector start and the sector split locations of the target sector from a memory.

14. The disk apparatus as defined in claim 12, wherein the disk formatting processor calculates the sector start and the sector split locations of the target sector.

15. The disk apparatus as defined in claim 11, wherein the command receiving unit enables data to be sent from a buffer storing the data to a read/write channel and from the read/write channel to the disk when the command received is for writing, and from the disk to a read/write channel and from the read/write channel to the buffer when the command received is for reading.

16. The disk apparatus as defined in claim 15, further comprising a memory for storing the data being transferred between the buffer and the read/write channel.

17. The disk apparatus as defined in claim 6, wherein the memory is a FIFO memory, and the command receiving unit enables the data to be moved into a memory.

18. The disk apparatus as defined in claim 17, further comprising a status unit for indicting the status of the FIFO memory to the processor.

19. The disk apparatus as defined in claim 11, wherein the disk formatter further comprises:
a servo counter for tracking a plurality of data fields on tracks of the disk;
a sector counter for tracking a plurality of sectors provided in the data fields; and
a comparator for comparing tracking information from the servo counter and the sector counter with the sector information obtained by the processor, and outputting a result of the comparison to the routing unit.

20. The disk apparatus as defined in claim 19, wherein the servo counter tracks the data fields provided between each pair of a plurality of servo wedges, and the sector counter tracks sectors between the servo wedges and sectors that are split by the servo wedges.
